(19) United States
(12) Patent Application Publication
(10) Pub. No.: US 2019/0386262 A1
(43) Pub. Date: Dec. 19, 2019

(54) CELL

(71) Applicant: Ningde Amperex Technology Limited, Ningde (CN)

(72) Inventors: Mingliang Mo, Ningde (CN); Wei Shu, Ningde (CN); Tao Tao, Ningde (CN); Jianzheng Sun, Ningde (CN)

(21) Appl. No.: 16/556,253

(22) Filed: Aug. 30, 2019

Related U.S. Application Data
(63) Continuation of application No. PCT/CN2017/111104, filed on Nov. 15, 2017.

(30) Foreign Application Priority Data
Mar. 2, 2017 (CN) 201710120627.4

(51) Int. Cl. H01M 2/02; H01M 10/0587; H01M 2/26; H01M 10/0525

(52) U.S. Cl. CPC H01M 2/0287; H01M 10/0587; H01M 10/0525; H01M 2/263; H01M 2/028; H01M 2/0285

(57) ABSTRACT

A cell comprises a jelly-roll and a package wrapped around the jelly-roll. The jelly-roll is formed by winding a first electrode plate, a second electrode plate opposite in polarity to the first electrode plate and a separator disposed between the first electrode plate and the second electrode plate. The first electrode plate is closer to the package than the second electrode plate, and a side of the outermost circumference of the first electrode plate facing the package is an uncoated region. The package includes a metal layer electrically connected to a tab of the second electrode plate, the metal layer being spaced apart from the uncoated region.

### CROSS-REFERENCE TO RELATED APPLICATION

This application is a continuation application of PCT application No. PCT/CN2017/111104 filed on Nov. 15, 2017, which claims priority to and benefits of Chinese Patent Application Serial No. 201710120627.4, filed with the China National Intellectual Property Administration on Mar. 2, 2017. The entire content of the above applications is incorporated herein by reference.

### FIELD OF THE APPLICATION

The present application relates to the field of energy storage, in particular, to a cell.

### BACKGROUND OF THE APPLICATION

Recently, there has been an increasing demand for devices such as portable devices and electric vehicles, etc. Therefore, in order to ensure the working hours of such products, the main way employed is to increase the energy density of the cell in the battery that power these products. However, as the energy density of the cell continues to increase, the cell is prone to thermal runaway in the event of an impact or piercing, thereby causing the cell to be easily burned and other problems and reducing the safety of the cell.

In order to solve such problems, the current common method in the industry is to extend the length of the blank current collector at the tailing end of the cell, specifically, to improve the safety performance of the lithium ion battery by sandwiching an separator between a blank positive current collector and a blank negative current collector to coat the inner cell containing electrolyte with a circle or even a plurality of turns. However, this structure increases the thickness of the cell, which is contrary to the development direction of its own high energy density. Therefore, the problem to be solved at present is how to ensure the energy density of the cell and ensure the use safety of the cell.

### SUMMARY OF THE APPLICATION

The present application provides a cell, which may not only ensure its own energy density, but also improve its own use safety.

The present application provides a cell, the cell includes a jelly-roll, and a package wrapped at the outside of the jelly-roll. The jelly-roll is formed by winding a first electrode, a second electrode opposite in polarity to the first electrode and an separator disposed between the first electrode and the second electrode; the first electrode is closer to the package than the second electrode, and a side of the outermost circumference of the first electrode facing the package is an uncoated region. The package includes a metal layer spaced from the uncoated region, and the metal layer is electrically connected to a tab of the second electrode.

In some embodiments, the metal layer has an inner surface facing the jelly-roll and an outer surface away from the jelly-roll. The package further includes an adhesive layer or an insulation layer, the adhesive layer covers at least a portion of the inner surface, the insulation layer covers at least a portion of the outer surface

In some embodiments, the package further includes an adhesive layer and an insulation layer, the adhesive layer covers at least a portion of the inner surface, the insulation layer covers at least a portion of the outer surface.

In some embodiments, the inner surface includes an adhesive surface covered with the adhesive layer and a inner connecting surface other than the adhesive surface, the tab is electrically connected on the inner connecting surface.

In some embodiments, the inner connecting surface is disposed directly opposite the portion of the tab in a direction perpendicular to a winding axis of the jelly-roll.

In some embodiments, the cell further includes a first conductive member, the first conductive member is disposed on the inner connecting surface, the tab is electrically connected to the metal layer through the first conductive member.

In some embodiments, an outermost circumference of the jelly-roll is an outermost circumference of the first electrode.

In some embodiments, the outer surface includes an insulation surface covered with the insulation layer and a outer connecting surface other than the insulation surface. The cell further includes a second conductive member, the second conductive member is disposed on the outer connecting surface, the tab is electrically connected to the metal layer through the second conductive member.

In some embodiments, the first electrode is a negative electrode, the second electrode is a positive electrode, and the metal layer is a metal aluminum layer that is electrically connected to the tab of the positive electrode.

In some embodiments, wherein the first electrode is a positive electrode, the second electrode is a negative electrode, and the metal layer is a stainless steel layer that is electrically connected to the tab of the negative electrode.

In some embodiments, the adhesive layer is disposed between the metal layer and the jelly-roll.

In some embodiments, when the cell is subjected to an impact from a metal foreign matter, the metal foreign matter first breaks through the metal layer of the package and then contacts the uncoated region on the outermost circumference of the first electrode.

In some embodiments, the inner surface of the metal layer is entirely covered with the adhesive layer.

In some embodiments, the insulation layer covers at least a portion of the outer surface of the metal layer.

In some embodiments, the entire outer surface of the metal layer is covered by the insulation layer.

In some embodiments, a portion of outer surface of the metal layer is covered by the insulation layer.

In some embodiments, when the portion of the package opposite to the tab is configured as a hollow structure and the inner wall surface of the hollow structure has a bare metal layer while the tab of the second electrode filling the entire hollow structure and being electrically connected to the bare metal layer in the hollow structure, or when the tab is electrically connected to the inner surface of the metal layer, the outer surface of the metal layer is not electrically connected to the tab.

In some embodiments, the outer surface of the metal layer is not entirely covered with the insulation layer, the portion not covered with the insulation layer is provided with the second conductive member, and the metal layer is electrically connected to the tab through the second conductive member.

In some embodiments, a non-conductive material is filled between a tab of the first electrode and the metal layer of the package.

The technical solution provided by the present application may achieve the following beneficial effects:

For the cell provided by the present application, the metal layer of the package is electrically connected to the tab on the second electrode while designing the side of the outermost circumference of the first electrode toward the package as an uncoated region, so that the metal foreign matter first breaks through the metal layer of the package and then contacts the uncoated region on the outermost circumference of the first electrode when the cell is subjected to an impact or piercing from a metal foreign matter. Since the metal layer of the package has been electrically connected to the tab on the second electrode, the cell is short-circuited while the short-circuited current flowing to the metal layer when the metal foreign matter contacts the uncoated region on the outermost circumference of the first electrode, and the metal layer quickly releases heat generated by the short circuit to reduce the probability that heat generated by the short circuit will be transferred to the electrolyte-rich electrode inside the cell, so that the internal heat generation of the cell is alleviated, and the situation that the cell is exploded and burned due to thermal runaway inside the cell is alleviated, thereby improving the use safety of the cell. Further, the design also enables the outermost circumference of the second electrode inside the jelly-roll to be provided without an uncoated region. Therefore, the occurrence of the burr of the uncoated region on the outermost circumference of the second electrode piercing the separator inside the cell may be avoided, and the use safety of the cell is further improved. And, in the case where the size of the cell remains the same, the energy density of the cell may also be increased since the outermost circumference of the second electrode does not have an uncoated region.

It should be understood that the above general description and the following detailed description are merely exemplary and are not intended to limit the present application.

### BRIEF DESCRIPTION OF THE ACCOMPANYING DRAWINGS

FIG. 1 is a plan schematic view of a cell according to an embodiment of the present application;

FIG. 2 is a cross-sectional structural schematic view of the cell shown in FIG. 1 taken along the A-A direction;

FIG. 3 is an enlarged structural schematic view of B shown in FIG. 2;

FIG. 4 is a plan schematic view of a cell provided according to another embodiment of the present application;

FIG. 5 is a cross-sectional structural schematic view of the cell shown in FIG. 4 taken along the C-C direction;

FIG. 6 is an enlarged structural schematic view of D shown in FIG. 5;

FIG. 7 is a schematic view showing the assembly of the tab of the second electrode and the package in a cell provided according to an embodiment of the present application;

FIG. 8 is a schematic view showing the assembly of the tab of the second electrode and the package in a cell provided according to another embodiment of the present application.

### REFERENCE NUMERALS

1—Jelly-roll;
10—First electrode plate;
11—Second electrode plate;
11a—Tab
12—Separator;
2—Package;
20—Metal layer;
21—Adhesive layer;
22—Insulation layer.
3—First conductive member;
4—Second conductive member.

The drawings herein are incorporated in and constitute a part of the specification, showing the embodiments of the present application and together with the description serve to explain the principles of the present application.

### DETAILED DESCRIPTION OF THE PREFERRED EXAMPLES

The present application will be further described in detail below through specific embodiments and with reference to the accompanying drawings.

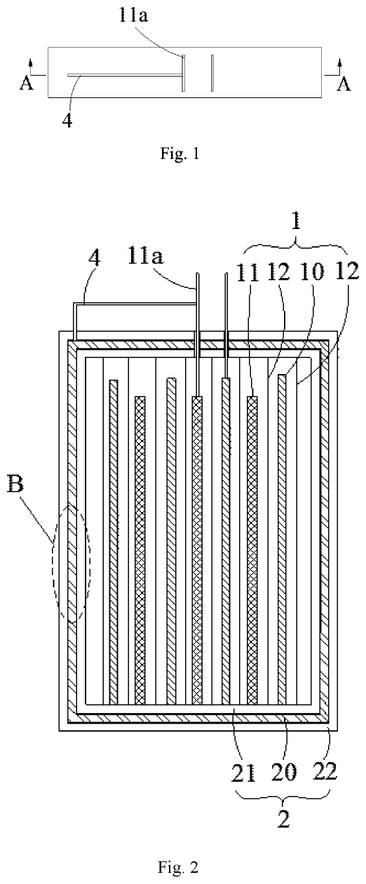

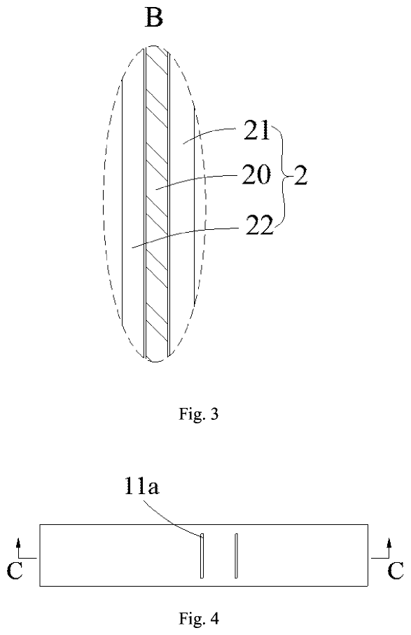

As shown in FIGS. 1 to 8, the embodiment of the present application provides a cell including a jelly-roll 1 and a package 2 covering the outside of the jelly-roll 1. The jelly-roll 1 refers to jelly roll type electrode assembly. The jelly-roll 1 is formed by winding a first electrode plate 10, a second electrode plate 11 opposite in polarity to the first electrode plate 10 and an separator 12 disposed between the first electrode plate 10 and the second electrode plate 11. The first electrode plate 10 is closer to the package 2 than the second electrode plate 11, and a side of the outermost circumference of the first electrode plate 10 facing the package 2 is an uncoated region, which is a region on the outermost circumference of the first electrode plate 10 that is not coated with an active substance layer. The package 2 includes a metal layer 20, the metal layer 20 may prevent the external liquid from infiltrating into the jelly-roll 1, and may also prevent the electrolyte in the jelly-roll 1 from leaking to the outside, thereby improving the use safety of the cell. In addition, the metal layer 20 is spaced from the uncoated region, and the metal layer 20 is electrically connected to the tab 11a of the second electrode plate 11.

In the present embodiment, since the metal layer 20 of the package 2 is electrically connected to the tab 11a on the second electrode plate 11 while designing the side of the outermost circumference of the first electrode plate 10 toward the package 2 as an uncoated region, the metal foreign matter first breaks through the metal layer 20 of the package 2 and then contacts the uncoated region on the outermost circumference of the first electrode plate 10 when the cell is subjected to special circumstances such as impact or piercing. Since the metal layer 20 of the package 2 has been electrically connected to the tab 11a on the second electrode plate 11, the cell is short-circuited while the short-circuited current flowing to the metal layer 20 when the metal foreign matter contacts the uncoated region on the outermost circumference of the first electrode plate 10, and the metal layer 20 quickly releases heat generated by the short circuit to reduce the probability that heat generated by the short circuit will be applied to the electrolyte-rich electrode plate inside the cell, so that the internal heat generation of the cell is alleviated, and the situation that the cell is exploded and burned due to thermal runaway inside the cell is alleviated, thereby improving the use safety of the cell. Further, the design also enables the outermost circumference of the second electrode plate 11 inside the jelly-roll 1 to be provided without an uncoated region. Therefore, the occurrence of the burr of the uncoated region on the outermost circumference of the second electrode plate 11 piercing the separator inside the cell may be avoided, and the use safety of the cell is further improved. And, in the case where the size of the cell remains the same, the energy density of the cell may also be increased since the outermost circumference of the second electrode plate 11 does not have an uncoated region.

It should be noted that when in normal use of the cell of the present embodiment, i.e. when the cell is not subjected to special conditions such as impact or piercing, no current flows to the metal layer 20 since the voltage at any of the metal layers 20 of the package 2 is the same.

In addition, it also should be noted that when the cell is subjected to special conditions such as impact or piercing, the metal foreign matter will break through the metal layer 20 of the package 2 and contact the uncoated region on the outermost circumference of the first electrode plate 10, thereby short-circuiting the cell; then in the event of the short circuit, most of the heat generated by the short circuit is released through the metal layer 20 since most of the current flows to the metal layer 20. However, when a short circuit occurs, the uncoated region on the outermost circumference of the first electrode plate 10 may also generate a certain amount of heat. Therefore, in order to further reduce the probability that thermal energy generated by the short circuit is applied to the electrode rich in electrolyte, preferably, the side of the outermost circumference of the first electrode plate 10 away from the package 2 may also be an uncoated region, that is, both of the opposite sides of the outermost circumference of the first electrode plate 10 are uncoated regions, so as to improve the use safety of the cell.

In the present embodiment, the metal layer 20 of the above package 2 has an inner surface facing the jelly-roll 1 and an outer surface away from the jelly-roll 1. In addition to the metal layer 20, the package 2 may include an adhesive layer 21 and/or an insulation layer 22.

Among which, the above adhesive layer 21 may cover the inner surface of the metal layer 20, and the sealing of the package 2 may be achieved by providing the adhesive layer 21 on the inner surface of the metal layer 20, so that the jelly-roll 1 may be packaged in the package 2 to prevent a foreign matter from entering the jelly-roll 1 and further prevent the electrolyte in the jelly-roll 1 from leaking to the outside. The adhesive layer 21 may also be closely adhered to the jelly-roll 1, so that the jelly-roll 1 may be prevented from shaking in the package 2, which otherwise may affect the use effect. Further, disposing the adhesive layer 21 between the metal layer 20 and the jelly-roll 1 may effectively reduce the probability of the metal layer 20 contacting the uncoated region of the outermost circumference of the first electrode plate 10, so as to ensure that the cell may be used normally. The insulation layer 22 may cover the inner surface of the metal layer 20; disposing the insulation layer 22 on the outer surface of the metal layer 20, may achieve the protection of the cell, and reduce the probability of the external electrified body contacting the metal layer 20, thereby improving the use safety of the cell.

The above adhesive layer 21 may be made of PP (polypropylene) material. The PP material may function to be an adhesive after heating, so that the sealing of the package 2 may be achieved. The insulation layer 22 may be made of a nylon material which is not electrically conductive, so that the external electrified body may be prevented from contacting the metal layer 20, which otherwise affects the normal use of the cell. It should be noted that the material of the adhesive layer 21 and the insulation layer 22 is not limited to the above-described form, and any material may be used as long as the effects of the adhesive layer 21 and the insulation layer 22 in the present embodiment may be attained.

In the present embodiment, when the package 2 includes the adhesive layer 21, the adhesive layer 21 may cover at least a portion of the inner surface. That is to say, when the package 2 includes the adhesive layer 21, the adhesive layer 21 may cover the inner surface of the metal layer 20 in two ways: the first one is that the entire inner surface of the metal layer 20 may be covered by the adhesive layer 21; the second one is that a part of inner surface of the metal layer is covered by the adhesive layer 21. The two coverage forms of the adhesive layer 21 are specifically described below:

For the first one, as shown in FIG. 7, the inner surface of the metal layer 20 of the package 2 includes an adhesive surface covered with the adhesive layer 21 and a inner connecting surface that is electrically connected to the tab 11a other than the adhesive surface. That is, the inner surface of the metal layer 20 is not entirely covered with the adhesive layer 21, and the portion not covered with the adhesive layer 21 is electrically connected to the tab 11a, so that the difficulty in connecting the metal layer 20 to the tab 11a of the second electrode plate 11 may be reduced, thereby effectively reducing the production cost of the cell.

Preferably, disposing the inner connecting surface directly opposite to the portion of the tab 11a in the direction perpendicular to the winding axis of the jelly-roll 1 may further reduce the difficulty in connecting the metal layer 20 to the tab 11a of the second electrode plate 11.

Further, the projection surface of the inner connecting surface may also be in the projection surface of the tab 11a disposed directly opposite thereto in the projection obtained in a direction perpendicular to the winding axis of the jelly-roll 1, so that the inner connecting surface occupies a smaller portion of the inner surface of the metal layer 20 while ensuring that the metal layer 20 is connected to the tab 11a. That is, the adhesive layer 21 occupies a larger portion of the inner surface of the metal layer 20, which may improve the encapsulation effect of the package 2, and may also effectively reduce the probability of contact between the metal layer 20 and the uncoated region of the outermost circumference of the first electrode plate 10, thereby improving the use safety of the cell.

Still further, the cell may further include a first conductive member 3, the first conductive member 3 is disposed on the inner connecting surface, and the tab 11a of the second electrode plate 11 may be electrically connected to the metal layer 20 through the first conductive member 3. In the present application, the electrical connection between the tab 11a of the second electrode plate 11 and the metal layer 20 achieved by the first conductive member 3 may prevent any one of the tab 11a and the metal layer 20 from being bent, so that the connection reliability between the tab 11a and the metal layer 20 is ensured in the case where the connection between the tab 11a and the metal layer 20 is realized.

For the second one, as shown in FIG. 8, the inner surface of the metal layer 20 of the package 2 is entirely covered with the adhesive layer 21, so that the package effect of the package 2 may be improved, and the probability of the metal layer 20 contacting the uncoated region of the outermost circumference of the first electrode plate 10 may be effectively reduced, thereby improving the use safety of the cell.

When the inner surface of the metal layer 20 is entirely covered with the adhesive layer 21, a portion of the adhesive layer 21 on the metal layer 20 may be hot pressed by a hot pressing jig to completely melt it, and a portion of the metal layer is exposed to be electrically connected to the tab 11a, wherein the final state after hot-pressing the package and the tab is shown in FIG. 8.

In addition, in the present embodiment, when the package 2 includes the adhesive layer 21 bonded to the inner surface of the metal layer 20, the outermost circumference of the jelly-roll 1 may be the outermost circumference of the first electrode plate 10 described above, that is, the jelly-roll 1 is only finished with the outermost circumference of the first electrode plate 10. When the cell is subjected to special conditions such as impact or piercing, the metal foreign matter will sequentially break through the metal layer 20 and the adhesive layer 21 of the package 2, and then contact with the outermost circumference of the jelly-roll 1, i.e., contact the uncoated region on the outermost circumference of the first electrode plate 10, so that the use of the separator 12 on the outermost circumference of the jelly-roll 1 may be reduced. Therefore, in the case where the thickness of the cell is constant, due to the lack of the use of the separator 12 on the outermost circumference for the jelly-roll 1 of the present application, the energy density of the jelly-roll 1 may be improved.

Among which, when the package 2 of the present embodiment includes the insulation layer 22, the insulation layer 22 may cover at least a portion of the outer surface, that is, when the package 2 includes the insulation layer 22, the coverage of the insulation layer 22 on the outer surface of the metal layer 20 may be performed by two solutions: the first one is that the entire outer surface of the metal layer 20 may be covered by the insulation layer 22; the second one is that a portion of outer surface of the metal layer 20 is covered by the insulation layer 22. The two coverage forms of the insulation layer 22 are specifically described below:

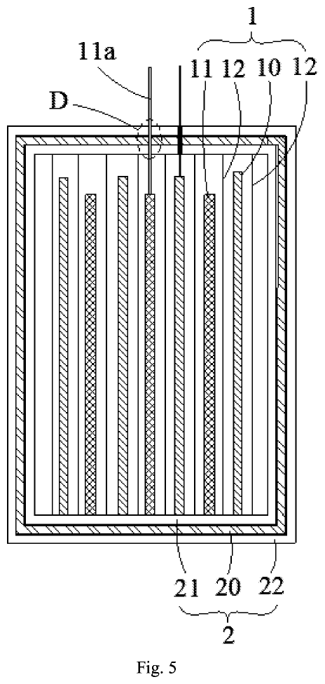

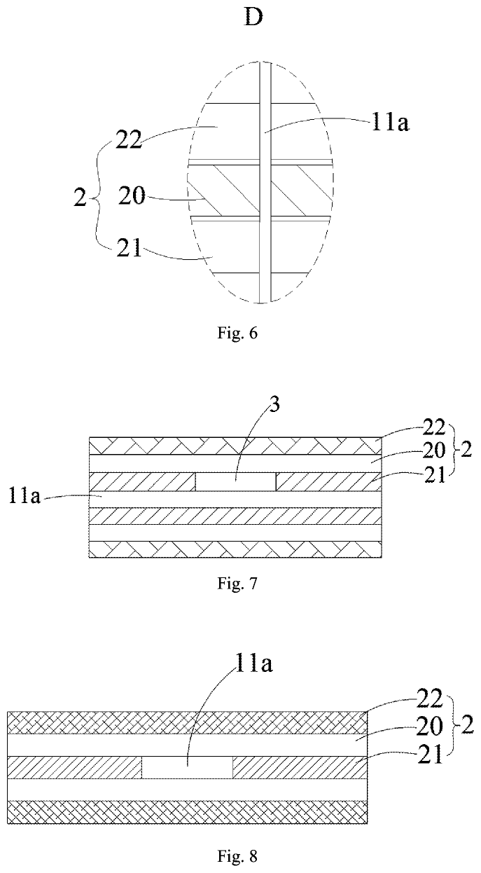

For the first one, as shown in FIGS. 5 and 6, when the portion of the package 2 opposite to the tab 11a may be configured as a hollow structure and the inner wall surface of the hollow structure has a bare metal layer 20 while the tab 11a of the second electrode plate 11 filling the entire hollow structure and being electrically connected to the bare metal layer 20 in the hollow structure, or when the tab 11a is electrically connected to the inner surface of the metal layer 20, the outer surface of the metal layer 20 may not be electrically connected to the tab 11a. Therefore, the outer surface of the metal layer 20 may be entirely covered with the insulation layer 22 to further reduce the probability of the external charged body contacting the metal layer 20 for improving the use safety of the cell.

For the second one, as shown in FIGS. 1 and 2, the above package 2 includes the insulation layer 22, and the outer surface of the metal layer 20 of the package 2 includes an insulation surface covered with the insulation layer 22 and a outer connecting surface other than the insulation surface; the cell further includes a second conductive member 4, the second conductive member 4 is disposed on the outer connecting surface, and the tab 11a is electrically connected to the metal layer 20 through the second conductive member 4. That is to say, the outer surface of the metal layer 20 is not entirely covered with the insulation layer 22, the portion not covered with the insulation layer 22 is provided with the second conductive member 4, and the metal layer 20 is electrically connected to the tab 11a through the second conductive member 4, so that the difficulty in connecting the metal layer 20 to the tab 11a of the second electrode plate 11 may be reduced, thereby effectively reducing the production cost of the cell.

It should be noted that in the second solution, the outer connecting surface may be placed in a place that is not easily contacted to reduce the probability of the external charged body contacting the metal layer 20 for improving the use safety of the cell.

In addition, it should also be noted that in the present embodiment, a non-conductive material is filled between the tab of the first electrode plate 10 and the metal layer 20 of the package 2 to prevent the tab of the first electrode plate 10 from electrically conducting with the metal layer 20 of the package 2.

Based on the above structure, taking the battery of the present application as a lithium ion battery as an example, the assembly relationship between the jelly-roll 1 and the package 2 is preferably as follows:

the first one: the first electrode plate 10 of the above jelly-roll 1 is a negative electrode plate, and the second electrode plate 11 thereof is a positive electrode plate; the metal layer 20 of the package 2 is a metal aluminum layer which is electrically connected to the tab of the positive electrode plate. That is to say, when the metal layer 20 of the package 2 is a metal aluminum layer, preferably, the metal aluminum layer is electrically connected to the tab of the positive electrode plate, wherein during the operation of the cell, since the negative electrode plate is at a low potential, the lithium ions in the cell may react at the junction between the tab of the negative electrode plate and the metal aluminum layer to form an aluminum-lithium (Al—Li) alloy if the metal aluminum layer is electrically connected to the tab of the negative electrode plate, which may cause severe corrosion of the junction between the tab of the negative electrode plate and the metal aluminum layer, affecting the normal use of the cell.

The second one: the first electrode plate 10 of the above jelly-roll 1 is a positive electrode plate, and the second electrode plate 11 thereof is a negative electrode plate; the metal layer 20 of the package 2 is a stainless steel layer which is electrically connected to the tab of the negative electrode plate. That is to say, when the metal layer 20 of the package 2 is a stainless steel layer, preferably, the stainless steel layer is electrically connected to the tab of the negative electrode plate, wherein during the operation of the cell, since the positive electrode plate is at a high potential, the iron in the stainless steel may undergo an oxidation reaction to be corroded for affecting the normal use of the cell if the stainless steel layer is electrically connected to the tab of the positive electrode plate.

The foregoing is merely illustrative of the preferred embodiments of the present application and is not intended to be limiting of the present application, and various changes and modifications may be made by those skilled in the art. Any modifications, equivalent substitutions, improvements, and the like within the spirit and principles of the application are intended to be included within the scope of the present application.

What is claimed is:

1. A cell, comprising:
a jelly-roll;
a package wrapped at the outside of the jelly-roll;
the jelly-roll is formed by winding a first electrode plate, a second electrode plate opposite in polarity to the first electrode plate and an separator disposed between the first electrode plate and the second electrode plate;
wherein the first electrode plate is closer to the package than the second electrode plate, and a side of the outermost circumference of the first electrode plate facing the package is an uncoated region; and
the package comprises a metal layer spaced from the uncoated region, and the metal layer is electrically connected to a tab of the second electrode plate.

2. The cell according to claim 1, wherein the metal layer has an inner surface facing the jelly-roll and an outer surface away from the jelly-roll; and
the package further comprises an adhesive layer or an insulation layer, the adhesive layer covers at least a portion of the inner surface, the insulation layer covers at least a portion of the outer surface.

3. The cell according to claim 1, wherein the metal layer has an inner surface facing the jelly-roll and an outer surface away from the jelly-roll; and
the package further comprises an adhesive layer and an insulation layer, the adhesive layer covers at least a portion of the inner surface, the insulation layer covers at least a portion of the outer surface.

4. The cell according to claim 3, wherein the inner surface comprises an adhesive surface covered with the adhesive layer and a inner connecting surface, the tab is electrically connected on the inner connecting surface.

5. The cell according to claim 4, wherein the inner connecting surface is disposed directly opposite the portion of the tab in a direction perpendicular to a winding axis of the jelly-roll.

6. The cell according to claim 5, further comprises a first conductive member, the first conductive member is disposed on the inner connecting surface, the tab is electrically connected to the metal layer through the first conductive member.

7. The cell according to claim 4, wherein an outermost circumference of the jelly-roll is an outermost circumference of the first electrode plate.

8. The cell according to claim 2, wherein the outer surface comprises an insulation surface covered with the insulation layer and a outer connecting surface other than the insulation surface; and
the cell further comprises a second conductive member, the second conductive member is disposed on the outer connecting surface, and the tab is electrically connected to the metal layer through the second conductive member.

9. The cell according to claim 1, wherein the first electrode plate is a negative electrode plate, the second electrode plate is a positive electrode plate, and the metal layer is a metal aluminum layer that is electrically connected to the tab of the positive electrode plate.

10. The cell according to claim 1, wherein the first electrode plate is a positive electrode plate, the second electrode plate is a negative electrode plate, and the metal layer is a stainless steel layer that is electrically connected to the tab of the negative electrode plate.

11. The cell according to claim 3, wherein the adhesive layer is made of polypropylene.

12. The cell according to claim 3, wherein the adhesive layer is disposed between the metal layer and the jelly-roll.

13. The cell according to claim 3, wherein when the cell is subjected to an impact from a metal foreign matter, the metal foreign matter first breaks through the metal layer of the package and then contacts the uncoated region on the outermost circumference of the first electrode plate.

14. The cell according to claim 4, wherein the inner surface of the metal layer is entirely covered with the adhesive layer.

15. The cell according to claim 3, wherein the insulation layer covers at least a portion of the outer surface of the metal layer.

16. The cell according to claim 15, wherein the entire outer surface of the metal layer is covered by the insulation layer.

17. The cell according to claim 15, wherein a portion of outer surface of the metal layer is covered by the insulation layer.

18. The cell according to claim 16, wherein when the portion of the package opposite to the tab is configured as a hollow structure and the inner wall surface of the hollow structure has a bare metal layer while the tab of the second electrode plate filling the entire hollow structure and being electrically connected to the bare metal layer in the hollow structure, or when the tab is electrically connected to the inner surface of the metal layer, the outer surface of the metal layer is not electrically connected to the tab.

19. The cell according to claim 17, wherein the outer surface of the metal layer is not entirely covered with the insulation layer, the portion not covered with the insulation layer is provided with the second conductive member, and the metal layer is electrically connected to the tab through the second conductive member.

20. The cell according to claim 1, wherein a non-conductive material is filled between a tab of the first electrode plate and the metal layer of the package.
